(19) United States
(12) Patent Application Publication
(10) Pub. No.: US 2017/0207744 A1
(43) Pub. Date: Jul. 20, 2017

(54) Photovoltaic System with Reflective Panel or Reflective Strip Assembly

(71) Applicant: PV INNOVATIONS, North Bay (CA)

(72) Inventors: Brian DENSHAM, Ajax (CA); Charles MAZZACATO, Toronto (CA); Dave RANEY, Orangeville (CA); Brock EVANS, Toronto (CA)

(73) Assignee: PV INNOVATIONS

(21) Appl. No.: 15/001,805

(22) Filed: Jan. 20, 2016

(51) Int. Cl. H02S 30/10; H02S 20/30; H02S 40/22

(52) U.S. Cl. CPC H02S 30/10; H02S 40/22; H02S 20/30

(57) ABSTRACT

There is provided in a preferred embodiment a photovoltaic system having a support frame assembly and a photovoltaic panel assembly having a photovoltaic panel and a reflective panel. The photovoltaic and reflective panel are each hingedly coupled to the support frame assembly to permit at least partial rotational movement thereof relative to the support frame assembly about generally horizontal first and second rotational axes, respectively, positioned proximal to each other. The photovoltaic and reflective panels extend generally forwardly from their respective first and second rotational axes to define a forwardly open inner wedge space therebetween, where a light receptive surface of the photovoltaic panel and a reflective surface of the reflective panel are oriented generally inwardly towards each other. The photovoltaic and reflective panels are resiliently biased their respective first and second resting positions.

### FIELD OF THE INVENTION

This invention relates to a photovoltaic system, most preferably a ground mount photovoltaic system, provided with a photovoltaic panel and a reflective panel or reflective strip assembly oriented to reflect light or sunlight to the photovoltaic panel for increasing generation of electricity, as well as a photovoltaic panel assembly having the photovoltaic panel and the reflective panel for attachment to a support frame assembly placed on a mounting surface.

### BACKGROUND OF THE INVENTION

A photovoltaic system or solar photovoltaic power system (hereinafter referred to as “photovoltaic system”) is a power system designed to convert solar energy to electricity using a material which exhibits the photovoltaic effect. Various known photovoltaic systems have been developed in the past to harvest light, such as the sunlight, as part of a larger utility-scale, grid-connected photovoltaic power station or a smaller scale ground mount, or rooftop or building integrated system typically intended for providing electricity to a residential home or a commercial building. In view of a growing interest towards generation and utilization of renewable energy, even smaller scale photovoltaic systems have been developed to power for example street lights, parking meters and telecommunication transmitters.

A photovoltaic system may broadly be divided into a solar array which includes an arrangement of photovoltaic or solar panels (hereinafter referred to as “photovoltaic panels”) for harvesting solar energy, and the balance of system which includes all components of the photovoltaic system other than the solar array, such as an inverter, electrical wirings and switches, a battery charger and a rechargeable battery. Considerable research and investments have been and continue to be directed towards increasing the energy conversion efficiency of the photovoltaic panels for converting the sunlight to electricity. It has been reported that in the last decade, the energy conversion efficiency of conventional photovoltaic panels or modules have increased from 15% to 20%. It has been estimated that solar energy remains to provide less than one percent of the world's total grid electricity. Further increases in the energy conversion efficiency may be expected to contribute to improved utilization of the solar energy, and potentially reduced reliance on non-renewable resources.

A known utility-scale solar power station in the northern hemisphere may for example include a solar array of multiple, ground mount photovoltaic panels arranged into a number of rows. Each photovoltaic panel may be coupled to a vertical mounting pole secured to the ground, and the panel is oriented thereon to face south at a tilt angle optimized for solar energy yield. Ordinarily, photovoltaic panels in a given row are spaced from those in an adjacent row located further south, to for example avoid shading from the adjacent row, as shading has been recognized to significantly reduce photovoltaic electrical output.

### SUMMARY OF THE INVENTION

The applicant has appreciated that any spacing between photovoltaic panels present in for example the known photovoltaic power station as described above or those included in a smaller scale residential or commercial photovoltaic system may represent loss of further potential space from which the solar energy may be harvested. The applicant has further appreciated that solar energy yield from the photovoltaic panels may be increased in ways other than by increasing the energy conversion efficiency of the photovoltaic panels, and which utilizes the sunlight directed to any intervening space between the photovoltaic panels.

One possible non-limiting object of the present invention is to provide a photovoltaic system for converting the sunlight to electricity, and which is intended for permitting improved solar energy yield for a given solar energy harvest area without necessarily requiring increased energy conversion efficiency.

Another possible non-limiting object of the present invention is to provide a photovoltaic system suitable for installation on a solar energy harvest ground of reduced area, and which is intended for permitting improved solar energy yield without strictly requiring significantly greater costs or installation or maintenance time.

Another possible non-limiting object of the present invention is to provide a photovoltaic system designed to reduce maintenance time and costs associated with removal of debris or snow collected on the included photovoltaic panels, while reducing loss of photovoltaic electrical output through different seasons of the year.

In view of the disadvantages of previously known devices or systems, the present invention provides in one simplified aspect a photovoltaic system which includes at least one photovoltaic panel and a reflective panel or a reflective strip assembly positioned adjacent to the photovoltaic panel for reflecting the sunlight directed thereon to the photovoltaic panel. In one embodiment, the photovoltaic panel has a forward end portion extending generally rearwardly towards a rearward end portion at a tilt angle between about 10° and 80° with respect to the level ground to define a generally upwardly oriented light receptive surface, and the reflective panel or the reflective strip assembly extends forwardly from the forward end portion or generally upwardly from the rearward end portion, the reflective panel or the reflective strip assembly being oriented to reflect the sunlight to the light receptive surface.

In one aspect, the present invention provides a photovoltaic system for converting sunlight to electricity, the system comprising a support frame assembly and a photovoltaic panel assembly, wherein the support frame assembly comprises a pair of laterally spaced panel mounting arms for placement on a mounting surface to extend generally upwardly therefrom, and wherein the photovoltaic panel assembly comprises: a photovoltaic panel having an upper longitudinal end portion and a forwardly oriented light receptive surface, the upper longitudinal end portion being hingedly coupled along lengths of the panel mounting arms to permit at least partial rotational movement of the photovoltaic panel about a first generally horizontal rotational axis between a first resting position and a first rotated position, wherein in the first resting position, the light receptive surface is oriented at a first tilt angle between about 10° and 80° relative to the level ground, and in the first rotated position, the light receptive surface is oriented at a second tilt angle greater than the first tilt angle relative to the level ground; a reflective panel having a lower panel portion and a forwardly oriented reflective surface, the lower panel portion being hingedly coupled along the lengths of the panel mounting arms to permit at least partial rotational movement of the reflective panel about a second rotational axis between a second resting position and a second forwardly rotated position, and optionally between the second resting position and a third rearwardly rotated position, wherein the second rotational axis is generally parallel to the first rotational axis; and a biasing assembly comprising first and second biasing members, the first biasing member being positioned for resiliently biasing the photovoltaic panel towards the first resting position, and the second biasing member being positioned for resiliently biasing the reflective panel towards the second resting position, wherein the lower panel portion is positioned adjacent to and generally above the upper longitudinal end portion, whereby the photovoltaic panel and the reflective panel in the respective first and second resting positions extend generally forwardly from the panel mounting arms to define a forwardly open inner wedge space therebetween, wherein the light receptive surface and the reflective surface are oriented generally inwardly towards each other to effect reflection of light or sunlight by the reflective surface at least in the second resting position to the light receptive surface.

In another aspect, the present invention provides a photovoltaic system for converting sunlight to electricity, the system comprising a support frame assembly and a photovoltaic panel assembly, wherein the support frame assembly comprises a pair of laterally spaced panel mounting arms for placement on a mounting surface to extend generally upwardly therefrom, and wherein the photovoltaic panel assembly comprises: a generally rectangular photovoltaic panel having an upper longitudinal end portion, a lower longitudinal end portion and a forwardly oriented light receptive surface, the upper longitudinal end portion being hingedly coupled along lengths of the panel mounting arms to permit at least partial rotational movement of the photovoltaic panel about a first generally horizontal rotational axis between a first resting position and a first rotated position, wherein in the first resting position, the light receptive surface is oriented at a first tilt angle between about 10° and 80° relative to the level ground, and in the first rotated position, the light receptive surface is oriented at a second tilt angle greater than the first tilt angle relative to the level ground; a reflective panel having an upper panel portion, a lower panel portion and a forwardly oriented reflective surface, the lower panel portion being hingedly coupled along the lengths of the panel mounting arms to permit at least partial rotational movement of the reflective panel about a second rotational axis between a second resting position and a second forwardly rotated position, and optionally between the second resting position and a third rearwardly rotated position, wherein the second rotational axis is generally parallel to the first rotational axis; and a biasing assembly comprising: a first biasing member for resiliently biasing the photovoltaic panel towards the first resting position, wherein the first biasing member comprises at least two leaf springs connected to the lower longitudinal end portion and associated said panel mounting arms; and a second biasing member for resiliently biasing the reflective panel towards the second resting position, wherein the second biasing member comprises at least one counterweight positioned along the lower panel portion to cantilever the upper panel portion from the second rotational axis, wherein the lower panel portion is positioned adjacent to and generally above the upper longitudinal end portion, whereby the photovoltaic panel and the reflective panel in the respective first and second resting positions extend generally forwardly from the panel mounting arms to define a forwardly open inner wedge space therebetween, wherein the light receptive surface and the reflective surface are oriented generally inwardly towards each other to effect reflection of light or sunlight by the reflective surface at least in the second resting position to the light receptive surface.

In yet another aspect, the present invention provides a photovoltaic panel assembly for converting sunlight to electricity, the photovoltaic panel assembly being for attachment to a support frame positioned on a mounting surface in a mounted arrangement, wherein the photovoltaic panel assembly comprises: a photovoltaic panel having opposed first and second longitudinal end portions and a light receptive surface, the first longitudinal end portion being for hingedly coupling to the support frame in the mounted arrangement to permit at least partial rotational movement of the photovoltaic panel about a first generally horizontal rotational axis between a first resting position and a first rotated position, wherein in the first resting position, the light receptive surface is oriented generally forwardly at a first tilt angle between about 10° and 80° relative to the level ground, and in the first rotated position, the light receptive surface is oriented generally forwardly at a second tilt angle greater than the first tilt angle relative to the level ground; a reflective panel having opposed first and second panel portions and a reflective surface, the second panel portion being for hingedly coupling to the support frame in the mounted arrangement to permit at least partial rotational movement of the reflective panel about a second rotational axis between a second resting position and a second forwardly rotated position, and optionally between the second resting position and a third rearwardly rotated position, wherein the second rotational axis is generally parallel to the first rotational axis; and a biasing assembly comprising first and second biasing members, the first biasing member being positionable in the mounted arrangement for resiliently biasing the photovoltaic panel towards the first resting position, and the second biasing member being positionable in the mounted arrangement for resiliently biasing the reflective panel towards the second resting position, wherein in the mounted arrangement, the second panel portion is positionable adjacent to and generally above the first longitudinal end portion, whereby the first longitudinal end portion and the second panel portion in the respective first and second resting positions extend generally forwardly towards the second longitudinal end portion and the first panel portion, respectively, to define a forwardly open inner wedge space between the photovoltaic panel and the reflective panel, wherein the light receptive surface and the reflective surface are positionable generally inwardly towards each other to effect reflection of light or sunlight by the reflective surface at least in the second resting position to the light receptive surface.

The applicant has appreciated that during operation, various environmental objects and debris, such as dust, leaves, snow and others may accumulate on the light receptive surface, thereby reducing the solar energy yield from the photovoltaic system. It has been envisioned that by incorporating the biasing assembly in the photovoltaic system of the present invention, snow, for example, accumulating on the photovoltaic panel may cause the panel to rotate downwardly until the snow falls to the mounting surface under gravity, and thereafter, returning the panel to the first resting position under the bias. Furthermore, incremental rotational movement of the photovoltaic panel towards the first rotated position under the weight of the accumulating snow thereon may effectively increase the panel's tilt angle in the winter time when the solar elevation angle is reduced. In one embodiment, the first biasing member is selected to permit the rotational movement of the photovoltaic panel towards the first rotated position against the resilient bias under a load applied generally downwardly to the photovoltaic panel, preferably under gravity, the load being greater than an opposing threshold biasing force, preferably selected to maintain the photovoltaic panel in the first resting position, wherein the rotational movement of the photovoltaic panel towards the first rotated position is proportional to an amount of the load exceeding the threshold biasing force.

It has been envisioned that the second biasing member may permit for, for example, reducing stresses and strains caused by a wind load placed on the photovoltaic system by allowing the reflective panel to rotate forwardly or rearwardly with the wind. In one embodiment, the second biasing member is selected to permit the rotational movement of the reflective panel towards the second forwardly rotated position and optionally the third rearwardly rotated position against the resilient bias under a further load applied to the reflective panel, the further load being greater than a further opposing threshold biasing force selected to maintain the reflective panel in the second resting position, wherein the rotational movement of the reflective panel towards the second forwardly rotated position or the third rearwardly rotated position is proportional to an amount of the further load exceeding the further threshold biasing force.

It is to be appreciated that the load and the further load are not particularly limited, and may include in one embodiment a dead load or an imposed load. Ordinarily, as suggested above when the photovoltaic system of the present invention is placed on the mounting surface located outdoors, the photovoltaic and reflective panels may be subject to an environmental load resulting from weather, topography and other natural phenomena. In one embodiment, the load comprises an environmental load having at least a snow load caused by snow accumulating on the light receptive surface, and the light receptive surface has a friction coefficient selected to permit relative movement of the snow towards the mounting surface when the photovoltaic panel is in or proximal to the first rotated position, and wherein the further load comprises a wind load caused by wind directed to the reflective panel.

In one embodiment, in the second resting position, the reflective panel is oriented at a reflective angle relative to the level ground substantially equal to or greater than a solar elevation angle at a solar noon of a day, thereby avoiding shading of the light receptive surface by the reflective panel during the day. It has been envisioned that when the reflective angle is greater than or preferably about equal to the solar elevation angle (the angle between the horizon and the center of the sun's disc) at a solar noon on a given day, shading by the reflective panel over the adjacently below photovoltaic panel may be avoided, while reducing sunlight reflection to the photovoltaic panel around the solar noon, so as to reduce the possibility of overheating the photovoltaic panel during for example the summer season. The second resting position or the reflective angle may be automatically adjusted according to the varying solar elevation angles throughout the year, or the reflective angle may be selected to be about equal to the solar elevation angle at a solar noon on a summer solstice at the mounting surface.

In one embodiment, the photovoltaic system of the present invention includes a plurality of the photovoltaic panel assemblies coupled to the support frame assembly. In one embodiment, the photovoltaic system further comprises a further one of said photovoltaic panel assembly, said further photovoltaic panel assembly being disposed generally below the photovoltaic panel assembly, wherein a most forward end or the lower longitudinal end portion of the respective photovoltaic panel of the photovoltaic panel assembly in the respective first resting position is positioned proximal to and/or generally above a most forward end or the upper panel portion of the respective reflective panel of the further photovoltaic panel assembly in the respective second resting position. It has been envisioned that with such arrangement, multiple photovoltaic panel assemblies may be secured to the support frame assembly. Preferably, the photovoltaic system includes one to twelve, preferably two to eight, more preferably three to five, or most preferably three of the photovoltaic panel assemblies secured to the support frame assembly.

It is to be appreciated that the support frame assembly is not strictly limited to including further specific components, provided that the photovoltaic panel assembly may be secured thereto. Preferably, the panel mounting arms are for placement on the mounting surface to extend generally upwardly and rearwardly therefrom at an angle between about 30° and about 85° relative to the mounting surface or the level ground. In one embodiment, the support frame assembly further comprises a pair of generally upright posts each having an upper end portion, each said post being for positioning on the mounting surface rearwardly from associated said panel mounting arm, and said associated panel mounting arm extending generally downwardly from the upper end portion towards the mounting surface at a frame angle between about 5° and about 60° relative to the post. In one embodiment, the support frame assembly further comprises a generally horizontal crossbar extending between the panel mounting arms proximal to the mounting surface, and one or more inner mounting arms coupled to the crossbar to extend generally upwardly therefrom, the inner mounting arms being oriented generally parallel to the panel mounting arms, wherein the photovoltaic panel and the reflective panel are further hingedly coupled to the inner mounting arms.

In one embodiment, the photovoltaic panel assembly further comprises at least two photovoltaic panel hinges located on the upper longitudinal end portion for rotatably engaging associated said panel mounting arms, and at least two reflective panel hinges located on the lower panel portion for rotatably engaging associated said panel mounting arms, and wherein the first and second biasing members each comprises at least one of a leaf spring, a coil spring, a bimetallic biasing member, such as a resiliently deformable bimetallic strip or a bimetallic leaf spring, and a counterweight.

The photovoltaic panel preferably includes a rearwardly oriented mounting surface opposed to the light receptive surface, and the photovoltaic panel hinges are coupled to the mounting surface. It is to be appreciated that the photovoltaic panels of the photovoltaic system may be commercially available photovoltaic panels formed with a number of photovoltaic modules fixedly attached to each other in a generally planar, side-by-side arrangement, and which includes a plurality of photovoltaic panel hinges extending rearwardly from the mounting surface at junctions between the photovoltaic modules along the upper longitudinal end portion. In one embodiment, the photovoltaic panel comprises a plurality of photovoltaic modules each comprising opposed upper and lower module portions, opposed lateral module portions and a module light receptive surface, wherein the photovoltaic modules are fixedly arranged in a coplanar arrangement with each of the lateral module portions of one said photovoltaic module being located adjacent to one said lateral module portion of another one of said photovoltaic module (except for the outermost lateral module portion of the outermost disposed photovoltaic modules), and wherein the module light receptive surfaces and the upper module portions cooperatively form the light receptive surface and the upper longitudinal end portion, respectively. In such embodiment, the frame support assembly preferably includes a plurality of said inner mounting arms, and the photovoltaic panel assembly includes a plurality of said photovoltaic panel hinges for rotatably engaging an associated one of said panel mounting arms and said inner mounting arms.

In one embodiment, the photovoltaic panel further comprises a lower longitudinal end portion opposed to the upper longitudinal end portion, and the first biasing member comprises two said leaf springs connected to the lower longitudinal end portion and associated said panel mounting arms, and wherein the reflective panel further comprises an upper panel portion opposed to the lower panel portion, and the second biasing member comprises at least one said counterweight positioned along the lower panel portion to cantilever the upper panel portion from the second rotational axis.

In an alternative embodiment, the first biasing member comprises at least one said coil spring coupled to at least one said photovoltaic panel hinges, the coil spring being a metal coil spring oriented in general alignment with the first rotational axis, wherein the metal coil spring is positioned to increase the first tilt angle of the light receptive surface in the first resting position with decreasing temperature, preferably with contraction of the metal coil spring with the decreasing temperature. In a further alternative embodiment, the second biasing member comprises at least one said coil spring coupled to at least one said reflective panel hinges, the coil spring being a metal coil spring oriented in general alignment with the second rotational axis, wherein the metal coil spring is positioned to decrease the reflective angle of the reflective surface in the second resting position with decreasing temperature, preferably with contraction of the metal coil spring with the decreasing temperature.

It is to be appreciated that the first and second biasing members may include other combinations of a leaf spring, a coil spring, a bimetallic biasing member, a counterweight and other biasing components. In one non-limiting embodiment, when the first biasing member includes leaf springs, the leaf springs may include bimetallic leaf springs configured to increase the first tilt angle of the photovoltaic panel in the first resting position with decreasing temperature.

It is to be appreciated that specific dimensions of the photovoltaic system is not particular limited. In one embodiment, the panel mounting arms extend between about 1 m and about 10 m, preferably between about 2 m and about 7 m or more preferably between about 3 m and 5 m, and are laterally spaced between about 1 m and about 25 m, preferably between about 3 m and about 20 m, or more preferably between about 5 m and about 10 m. In one embodiment, the photovoltaic panel has a width between about 0.1 m and about 3 m, preferably between about 0.4 m and about 2 m, more preferably between about 0.8 m and 1.5 m or most preferably about 1 m. The photovoltaic panel has a length substantially identical to the lateral spacing between the panel mounting arms, although the length may be greater than the lateral spacing.

In one embodiment, the reflective panel has dimensions, preferably length, generally identical to those of the photovoltaic panel. In one embodiment, the reflective panel comprises a plurality of reflective panel units arranged in a generally coplanar, side-by-side arrangement in the second resting position, each reflective panel unit comprising opposed upper and lower panel unit portions, opposed lateral panel unit portions and a panel unit reflective surface, wherein in the second resting position each of the lateral panel unit portions of one said reflective panel unit is positionable adjacent to one said lateral panel unit portion of another one of said reflective panel unit (except for the outermost lateral panel unit portion of the outermost disposed reflective panel units), wherein the reflective panel unit surfaces and the lower panel unit portions cooperatively form the reflective surface and the lower panel portion, respectively.

In one embodiment, the reflective panel units are or are not fixedly attached to each other. In the embodiment where the reflective panel units are not fixedly attached to each other, each said reflective panel unit is rotatable between the second resting and rotated positions independently of other said reflective panel units about the second rotational axis, each said reflective panel unit comprising at least one said reflective panel hinge rotatably engaging at least one said panel mounting arms and inner mounting arms, and at least one said second biasing member. In the embodiment where the photovoltaic panel comprises the photovoltaic modules, each said reflective panel unit is preferably positioned adjacently above associated said photovoltaic module, the respective lower panel unit portion and the respective upper module portion being preferably adjacent to and aligned with each other.

The photovoltaic system may be a ground mount photovoltaic system for placement on the mounting surface, the mounting surface being substantially level ground. Alternatively, the photovoltaic system may be mounted on a flat or slanted rooftop, or to a lateral surface of a building. It is to be appreciated that in the embodiment where the photovoltaic system is attached to the building's lateral surface, upper ends of the panel mounting arms are preferably attachable to the building's lateral surface to extend generally downwardly and forwardly away from the building's lateral surface and towards lower ends of the panel mounting arms. In the aforementioned embodiment, the support frame assembly preferably further includes a pair of generally horizontal lower beams attachable to the building's lateral surface to extend generally forwardly therefrom towards respective forward engagement ends, wherein each said forward engagement ends are coupled to an associated one of said lower ends of the panel mountings arms.

In one embodiment, the system further comprises one or more balance-of-system elements selected from the group consisting of a solar tracker, an electrical inverter, a maximum power point tracker, a solar irradiance sensor and a rechargeable battery.

In yet another aspect, the present invention provides a photovoltaic system for converting sunlight to electricity, the system comprising at least first and second photovoltaic panel assemblies each comprising a support base member and a photovoltaic panel secured on the support base member, wherein the photovoltaic panel comprises a forward end portion extending rearwardly towards a rearward end portion at a tilt angle between about 10° and about 80° with respect to the level ground to define an upwardly oriented slanted light receptive surface, and the second panel assembly is for placement rearwardly of the first panel assembly, the system further comprising one or more reflective strip assemblies for reflecting the light or sunlight to the light receptive surface of the second panel assembly, wherein each said reflective strip assembly extends longitudinally from the second panel assembly proximal to the respective forward end portion towards the first panel assembly proximal to the respective rearward end portion at a reflection angle between about 5° and about 70° with respect to the level ground, and wherein each said reflective strip assembly comprises a plurality of reflector members located along a length of the reflective strip assembly, each said reflector member having an outer reflective surface positionable in or movable towards a level sunlight reflecting orientation, wherein in the level sunlight reflecting orientation, the reflective surface is directed generally rearwardly to face the light receptive surface of the second panel assembly to reflect the sunlight thereto.

In yet another aspect, the present invention provides a reflective strip assembly for attachment to first and second photovoltaic panel assemblies to reflect the light or sunlight to the second panel assembly in a mounted arrangement, each said panel assembly comprising a photovoltaic panel having a forward end portion extending rearwardly towards a rearward end portion at a tilt angle between about 10° and about 80° with respect to the level ground to define an upwardly oriented slanted light receptive surface, and the second panel assembly being for placement rearwardly of the first panel assembly, wherein the reflective strip assembly is for positioning in the mounted arrangement to extend from the second panel assembly proximal to the respective forward end portion towards the first panel assembly proximal to the respective rearward end portion at a reflection angle between about 5° and about 70° with respect to the level ground, and wherein the reflective strip assembly comprises a plurality of reflector members located along a length of the reflective strip assembly, each said reflector member having an outer reflective surface positionable in or movable towards a level sunlight reflecting orientation in the mounted arrangement, wherein in the level sunlight reflecting orientation, the reflective surface is directed generally rearwardly to face the light receptive surface of the second panel assembly to reflect the sunlight thereto.

It is to be appreciated that the reflective strip assembly is not intended to be limited to specific structures, provided that the reflective strip assembly operates to reflect the sunlight to the photovoltaic panel. In one embodiment, the reflective strip assembly further comprises an elongated cord extending at least partially between the first and second panel assemblies, and each said reflector member defines an axially open bore for receiving the cord therethrough, and wherein the reflector member is fixedly disposed along the length of the cord with the respective reflective surface in the reflecting orientation or rotatably disposed along the length of the cord, whereby the reflector member is rotatably biased to move the reflective surface towards the reflecting orientation. In one embodiment, the elongated cord may alternatively be an elongated rod. The cord or rod preferably has a cross sectional profile selected from the group consisting of a circle, an ellipse, a triangle, a square, a rectangle, a pentagon, a hexagon and an octagon.

It has been appreciated that by rotatably disposing the reflector member along the length of the cord, such that each said reflector member is rotatable against the bias along a rotation axis substantially aligned with the length of the elongated cord, debris, leaves, snow and others accumulating on the reflective surface in the reflecting orientation may rotate the reflector member under gravity against the bias, and the reflective surface will thereafter return to the reflecting orientation.

In one embodiment, the reflector member is rotatably disposed along the length of the cord, and wherein the reflector member further comprises a counterweight located distal to the reflective surface, whereby the bore is interposed between the counterweight and the reflective surface, wherein the counterweight biases the reflective surface under gravity towards the reflecting orientation. In the foregoing embodiment, the cord or rod preferably has a circular cross sectional profile to permit rotatable movement of the reflector member along the length of the cord or rod. A skilled artisan would readily appreciated other manners or components which may be utilized to bias the reflective surface towards the reflecting orientation when the reflector member is rotatable disposed along the cord length, and which by way of non-limiting examples include a leaf spring connected between the cord and the reflector member. Furthermore, to retain the rotatably disposed reflector member at a longitudinal position along the cord length, the reflective strip assembly may further include a retention collar fixedly disposed along the cord length, and at least one said reflector member disposed proximal to the second panel assembly relative to the retention collar is in contact with the retention collar under gravity.

In an embodiment in which the reflector member is fixedly disposed along the length of the cord, the reflective strip assembly may further include other components selected for removing debris, leaves, snow and others accumulating on the reflective surface in the reflecting position. In one non-limiting embodiment, the reflective strip assembly further comprises first and second end fasteners each coupled to an associated longitudinal end of the cord for attachment to the first and second panel assemblies, respectively, at least one of said fasteners comprising a rotator or a vibrator for removing an object accumulated on the reflective surface, wherein said rotator is selectively operable to rotate at least one of the cord and the reflector member along a longitudinal axis of the cord, and wherein said vibrator is selectively operable to transmit a vibrational movement or force to at least one of the cord and the reflector member. It is to be appreciated that one or both of said fasteners may include the rotator, the vibrator or a combination thereof. In one embodiment, the reflector member is fixedly disposed along the length of the cord, and both said first and second fasteners include associated said rotator, wherein the rotators are selectively operable to cooperatively rotate the cord along the longitudinal axis in one direction, thereby effecting removal of the object under gravity. Preferably, to assist removal of the object, one or both said first and second fasteners further comprise the vibrator. In one embodiment, the rotator or the vibrator comprises a battery or receives electrical power from the photovoltaic system or the photovoltaic panel. In one embodiment, the rotator or the vibrator are selected to rotate or vibrate the cord and/or the reflector member at pre-determined times or time intervals.

By way of non-limiting embodiments, the reflective strip assembly may be a rigid or flexible reflective strip assembly, or include a combination of rigid and flexible longitudinal portions. In one embodiment, the cord comprises a flexible cord having a length selected to concave generally downwardly under gravity between the first and second panel assemblies, thereby effecting focusing of the sunlight reflected from the respective reflective surfaces of the plurality of reflector members in the reflecting orientation to the light receptive surface of the second panel assembly. In one embodiment, the flexible cord comprises a metal cable or a rope.

It is to be appreciated that the tilt angle, the reflection angle and the mounting angle may be determined depending on the specific location, or the longitude or latitude, the photovoltaic of the present invention is to be placed, and the sun path at the location.

In one embodiment, the cord comprises first and second rigid longitudinal cord sections, the first cord portion being disposed proximal to the second panel assembly at a first cord angle between about 20° and about 25° with respect to the level ground and the second cord portion being disposed proximal to the first panel assembly at a second cord angle between about 28° and about 33° with respect to the level ground, and wherein the tilt angle is between about 40° and about 65°.

The photovoltaic panel may include different shapes, such as a square, a triangle, a circle, an ellipse, a rectangle and a pentagon. In one embodiment, the photovoltaic panel has a generally rectangular shape, and the forward and rearward end portions include respective forward and rearward longitudinal edges oriented generally parallel to each other, and wherein the system comprises multiple said reflective strip assemblies, each said reflective strip assemblies being oriented substantially normal to said longitudinal edges, and the respective reflective surfaces of the reflector members of the multiple reflective strip assemblies in the sunlight reflecting orientation cooperatively define a collective reflection surface for reflecting the sunlight to the light receptive surface of the second panel assembly. In one embodiment, the collective reflection surface is a substantially continuous surface, wherein the reflective surface of each said reflector member in the reflecting orientation are positioned adjacent to the reflective surface of other said reflector members.

In one embodiment, the reflective strip assembly further comprises a hook and loop fastener for removably securing the reflective strip assembly to the first and second panel assemblies. In one embodiment, the reflective strip assembly is coupled to the forward end portion of the second panel assembly and the rearward end portion of the first panel assembly.

It is to be appreciated that the reflective surface may be obtained with any reflective material, provided that the reflective surface thus obtained operates to reflect light or sunlight to the light receptive surface. In one embodiment, the reflective surface comprises a biaxially-oriented polyethylene terephthalate (BoPET).

In one embodiment, the tilt angle is between about 46° and about 57°, and the system is for placement at a location having a sun declension angle ranging between about 15° and about 75°.

In one embodiment, the system is a grid connected, ground mount photovoltaic system, the support base member comprising a generally vertically oriented pole secured on a mounting surface, and the system further comprises one or more balance-of-system elements selected from the group consisting of a solar tracker, an electrical inverter, a maximum power point tracker, a solar irradiance sensor and a rechargeable battery.

In one embodiment, the reflective strip assembly further comprises an elongated cord, and each said reflector member defines an axially open bore for receiving the cord therethrough, and wherein the reflector member is fixedly disposed along the length of the cord with the respective reflective surface generally directed in the reflecting orientation in the mounted arrangement or rotatably disposed along the length of the cord, whereby the reflector member is rotatably biased to move the reflective surface towards the reflecting orientation in the mounted arrangement.

In one embodiment, the cord comprises a flexible cord having a length selected to concave downwardly under gravity in the mounted arrangement, thereby effecting focusing of the sunlight reflected from the respective reflective surfaces of the plurality of reflector members in the reflecting orientation to the light receptive surface of the second panel assembly.

In one embodiment, the cord comprises first and second rigid longitudinal cord sections, wherein in the mounted arrangement, the first cord portion is for placement proximal to the second panel assembly at a first cord angle between about 20° and about 25° with respect to the level ground and the second cord portion is for placement proximal to the first panel assembly at a second cord angle between about 28° and about 33° with respect to the level ground, and wherein the tilt angle is between about 40° and about 65°.

In one embodiment, the reflective strip assembly further comprises first and second end fasteners each coupled to an associated longitudinal end of the cord for attachment to the first and second panel assemblies, respectively, at least one of said fasteners comprising a rotator or a vibrator for removing an object accumulated on the reflective surface in the mounted arrangement, wherein said rotator is selectively operable to rotate at least one of the cord and the reflector member along a longitudinal axis of the cord, and wherein said vibrator is selectively operable to transmit a vibrational movement or force to at least one of the cord and the reflector member.

In one embodiment, the reflector member is rotatably disposed along the length of the cord, and wherein the reflector member further comprises a counterweight located distal to the reflective surface, whereby the bore is interposed between the counterweight and the reflective surface, wherein the counterweight is for biasing the reflective surface in the mounted arrangement under gravity towards the reflecting orientation.

In one embodiment, the reflective strip assembly is for coupling to the forward end portion of the second panel assembly and the rearward end portion of the first panel assembly.

### BRIEF DESCRIPTION OF THE DRAWINGS

Reference may now be had to the following detailed description taken together with the accompanying drawings in which:

FIG. 1 is a perspective view of a photovoltaic system which includes a base frame assembly and three photovoltaic panel assemblies each having a respective light reflecting panel and a respective photovoltaic panel in accordance with a preferred embodiment of the present invention, and which is shown as secured to a mounting ground;

FIG. 2 is a partial perspective view of the respective photovoltaic panel of one of the photovoltaic panel assemblies shown in FIG. 1, and which is shown as coupled to the base frame assembly;

FIG. 3 is a partial perspective view of two photovoltaic modules included with the photovoltaic panel shown in FIG. 2, and which is shown as coupled to the base frame assembly;

FIG. 4 is a partial side elevation view of one photovoltaic module included with the photovoltaic panel shown in FIG. 2, and which is shown as coupled to the base frame assembly;

FIG. 5 is a partial perspective view of the respective light reflecting panel of one of the photovoltaic panel assemblies shown in FIG. 1, and which is shown as coupled to the base frame assembly;

FIG. 6 is another partial perspective view of the light reflecting panel shown in FIG. 5; and

FIG. 7 is a partial side elevation view of the one light reflecting panel unit included with the light reflecting panel shown in FIGS. 5 and 6, and which is shown as coupled to the base frame assembly.

### DETAILED DESCRIPTION OF THE PREFERRED EMBODIMENTS

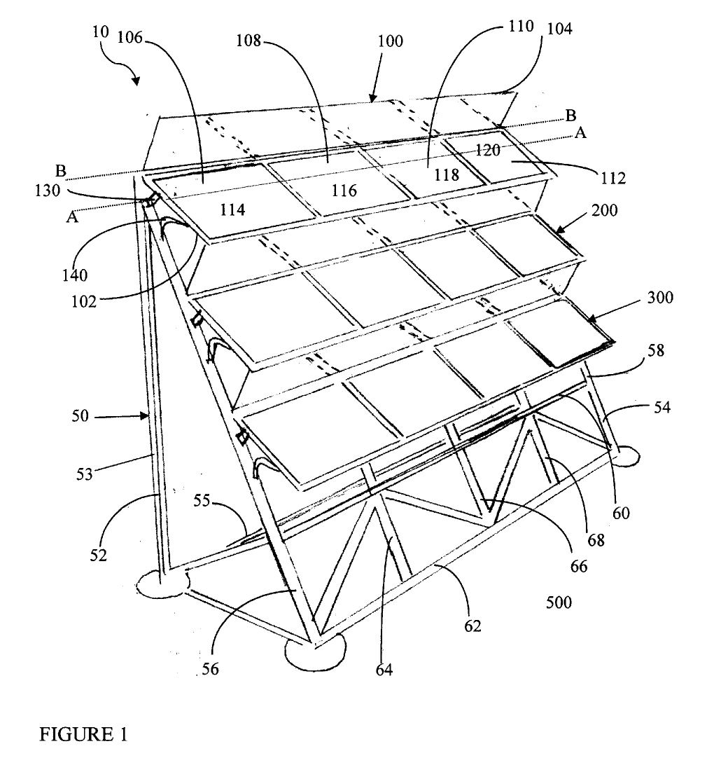

Reference is made to FIG. 1 which shows a perspective view of a photovoltaic system 10 having a base frame assembly 50 and photovoltaic panel assemblies 100, 200, 300 in accordance with a preferred embodiment of the present invention. In the construction shown, the base frame assembly 50 is secured over a mounting ground 500 and includes a substantially upright rearward frame portion 52 and a slanted forward frame portion 54, and the photovoltaic panel assemblies 100, 200, 300 are secured to the forward frame portion 54. As shown in use, the photovoltaic panel assemblies 100, 200, 300 extend generally forwardly from the forward frame portion 54.

As seen in FIG. 1, the base frame assembly 50 broadly includes the slanted forward frame portion 54 and the upright rearward frame portion 52 integrally joined to the slanted forward frame portion 54 to form the base frame assembly 50. The rearward frame portion 52 has a pair of transversely spaced vertical posts 53 (one not shown) and a rearward base crossbar 55 extending between the vertical posts 53 proximal to the mounting ground 500. The slanted forward frame portion 54 has a pair of outer support beams 56, 58 extending downwardly from uppermost ends of associated said vertical posts 53 (one not shown) to the mounting ground 500 at an acute angle relative to the vertical posts. The forward frame portion 54 further includes upper and lower forward crossbars 60, 62 extending transversely between the outer support arms 56, 58 in a generally parallel orientation to each other, and inner support beams 64, 66, 68 extending upwardly from the lower forward crossbar 62 and coupled to the upper forward crossbar 60. The inner support beams 64, 66, 68 are oriented parallel to, and have substantially same lengths as, the outer support beams 56, 58.

The photovoltaic panel assembly 100 includes a planar photovoltaic panel 102 and a light reflecting panel 104. The photovoltaic panel 102 includes a plurality of generally rectangular photovoltaic modules 106, 108, 110, 112 fixedly coupled to each other in a generally coplanar, side-by-side arrangement with each other to cooperatively form the photovoltaic panel 102. The photovoltaic modules 106, 108, 110, 112 has respective forwardly oriented light receiving surfaces 114, 116, 118, 120 each comprising a plurality of photovoltaic cells (not shown) for receiving light or sunlight thereon to be converted to electricity.

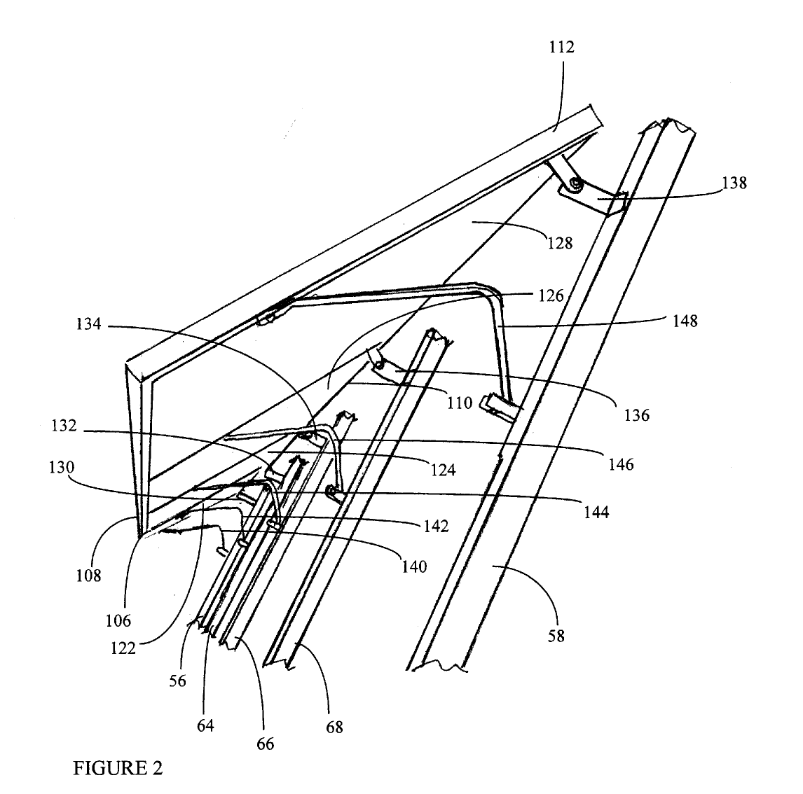

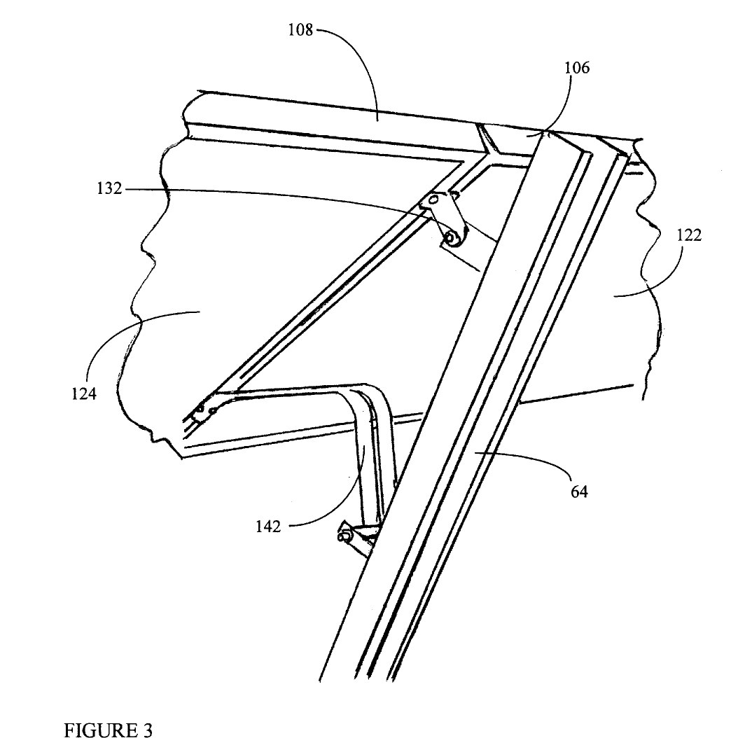

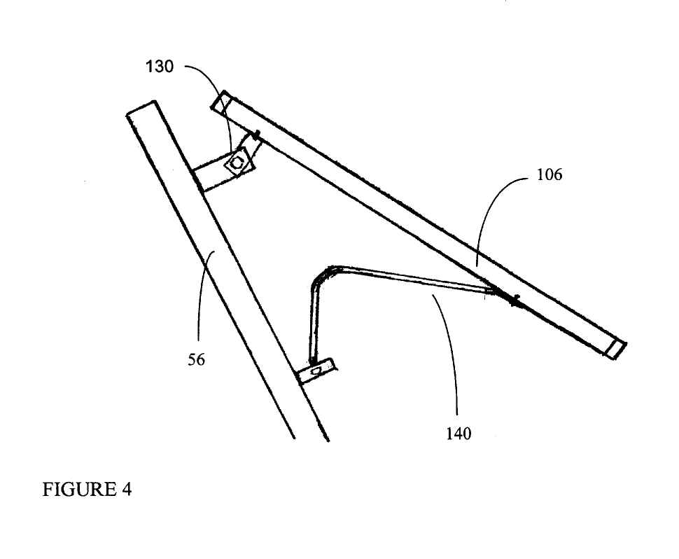

Reference is now made to FIGS. 2 to 4 which show different views of the photovoltaic panel 102 in isolation from the light reflecting panel 104 for more clear illustration. It is to be seen that opposed to the light receiving surfaces 114, 116, 118, 120 are rearwardly oriented panel attachment surfaces 122, 124, 126, 128. The photovoltaic panel 102 further includes photovoltaic panel mounting hinges 130, 132, 134, 136, 138 extending rearwardly from the panel attachment surfaces 122, 124, 126, 128 for rotatably coupling to associated outer and inner support beams 56, 58, 64, 66, 68, and rearwardly directed leaf springs 140, 142, 144, 146, 148 coupled to the panel attachment surfaces 122, 124, 126, 128 for resiliently biasing the photovoltaic panel 102 towards a first resting position, as will be further discussed below.

The photovoltaic panel mounting hinges 130, 132, 134, 136, 138 are located directly upwardly relative to the leaf springs 140, 142, 144, 146, 148, respectively, on the panel attachment surfaces 122, 124, 126, 128. The mounting hinges 130, 138 and the leaf springs 140, 148 are positioned along associated outermost lateral edge portions of the modules 106, 112, respectively, and the mounting hinges 132, 134, 136 and the leaf springs 142, 144, 146 are located along associated lateral junctions between the surfaces 122, 124, the surfaces 124, 126 and the surfaces 126, 128, respectively. As seen in FIGS. 2 to 4, the photovoltaic panel mounting hinges 130, 132, 134, 136, 138 and the leaf springs 140, 142, 144, 146, 148 are connected to the outer/inner support arms 56, 64, 66, 68, 58, respectively.

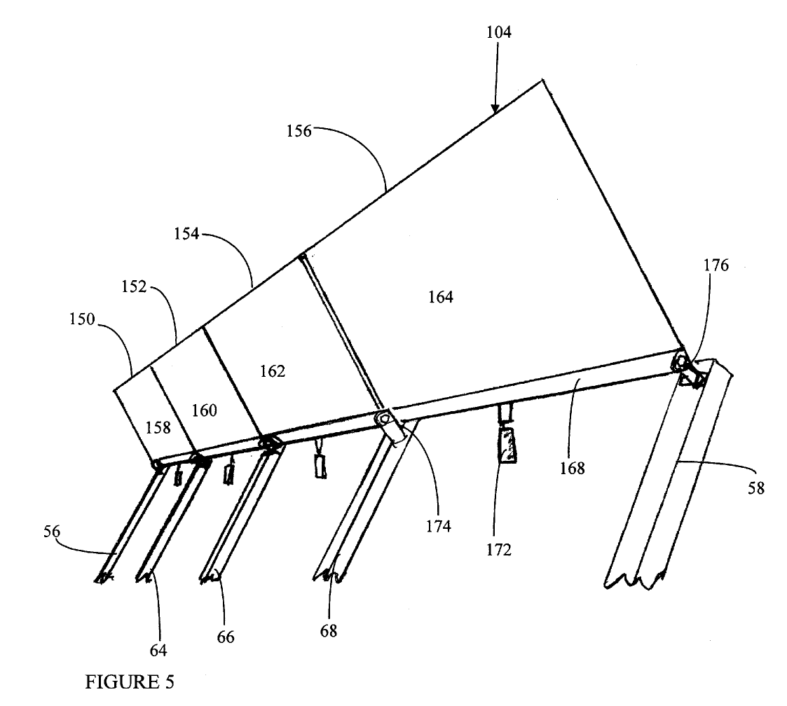

Reference is made to FIGS. 5 to 7 which show different views of the light reflecting panel 104 in isolation from the photovoltaic panel 102 for more clear illustration. The light reflecting panel 104 is formed with four substantially identical light reflecting panel units 150, 152, 154, 156 which are not connected or coupled to each other. Each of the light reflecting panel units 150, 152, 154, 156 are provided with a light reflecting surface 158, 160, 162, 164 (such as mirrors), respectively, for reflecting light or sunlight to the light receiving surfaces 114, 116, 118, 120, respectively, at least in a second resting position, as will be further described below.

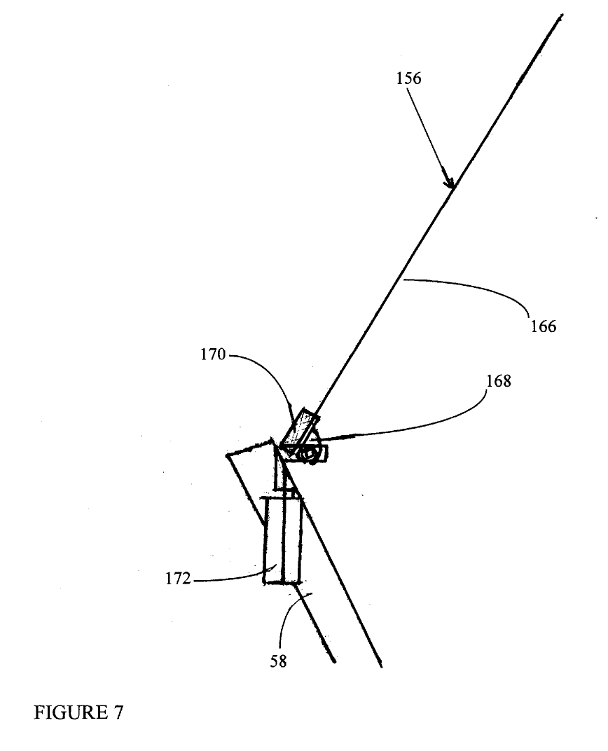

As more clearly seen in FIG. 7, the light reflecting panel unit 156 includes a generally rectangular light reflecting plate 166 provided with the light reflecting surface 164, elongated forward and rearward clamping bars 168, 170, and a counterweight 172. Respective inward surfaces of the clamping bars 168, 170 are lined with resiliently deformable material, such as rubber (not shown), and a lower edge portion of the light reflecting plate 166 is frictionally engaged between the resiliently deformable material of the clamping bars 168, 170. The counterweight 172 is coupled to the rear clamping bar 170, and the forward clamping bar 168 is provided with a pair of laterally disposed reflecting panel unit hinges 174, 176, as seen in FIG. 5, for rotatably coupling to the support beams 68, 58, respectively.

The remaining other light reflecting panel units 150, 152, 154 incorporate construction identical to that of the unit 156, with the exception that the respective hinges of the panel units 150, 152, 154 are for rotatably coupling to the support beams 56, 64, the support beams 64, 66, and the support beams 66, 68, respectively.

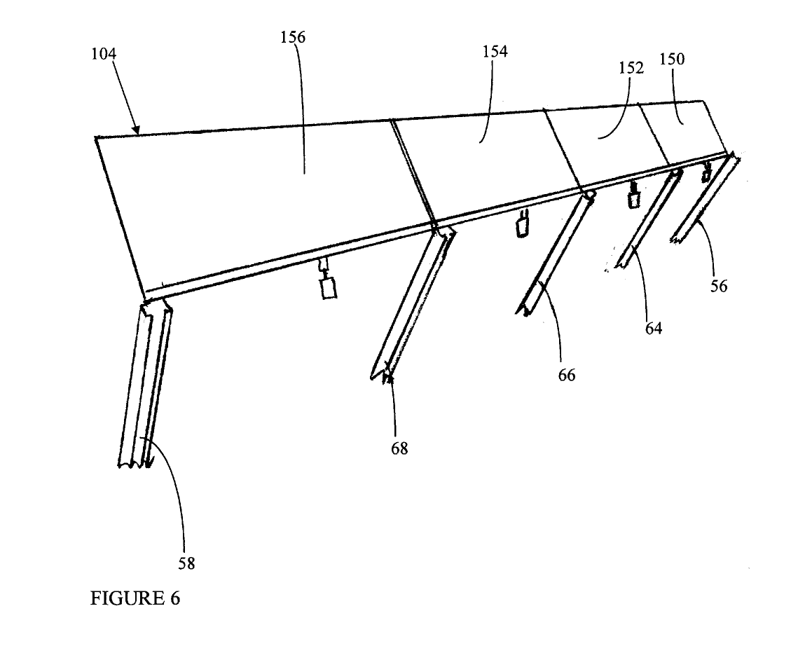

For assembly, the photovoltaic panel 102 is rotatably mounted to the base frame assembly 50 by connecting the photovoltaic panel mounting hinges 130, 132, 134, 136, 138 and the leaf springs 140, 142, 144, 146, 148 to the outer/inner support arms 56, 64, 66, 68, 58, respectively, such that the light receiving surfaces 114, 116, 118, 120 are oriented at a tilt angle of about 35° relative to the level ground when no load is applied the photovoltaic panel 102. As more clearly seen in FIGS. 5 and 6, the respective reflecting panel unit hinges of the light reflecting panel units 150, 152, 154, 156 are connected to the associated support beam 56, 58, 64, 66, 68, such that the respective light reflecting plates are rotatably cantilevered forwardly about the respective hinges with the respective counterweights acting as a counterbalance.

As seen in FIG. 1, the lower longitudinal edge portions of the light reflecting panel units 150, 152, 154, 156 are positioned proximal to and generally above an upper longitudinal edge portion of the photovoltaic panel 102, such that the panels 102, 104 extend generally forwardly from the base frame assembly 50 to define an inwardly oriented wedge space therebetween. Furthermore, the respective light reflecting plates of the units 150, 152, 154, 156 have widths substantially identical to those of the associated photovoltaic modules 106, 108, 110, 112 located directly below, and the reflecting panel units 150, 152, 154, 156 are vertically aligned with the associated photovoltaic modules 106, 108, 110, 112 below.

The photovoltaic panel assemblies 200, 300 are identical to the assembly 100. The assembly 200 is similarly hingedly coupled to the base frame assembly 50 generally below the assembly 100, such that a forwardmost longitudinal edge portion of the photovoltaic panel 102 is positioned proximal to and generally above an upper longitudinal edge portion of the respective light reflecting panel of the assembly 200. Likewise, the assembly 300 is hingedly coupled to the base frame assembly 50 generally below the assembly 200, such that a forwardmost longitudinal edge portion of the respective photovoltaic panel of the assembly 200 is positioned proximal to and generally above an upper longitudinal edge portion of the respective light reflecting panel of the assembly 300.

For operation, the photovoltaic system 10 is placed on the mounting ground 500 located at latitude of about 43° 55″, where the solar elevation angle at the solar noon on summer solstice is about 69.7°, and that at the solar noon on winter solstice is about 22.8°. The photovoltaic system 10 is oriented on the mounting ground 500 to have the included photovoltaic and light reflecting panels of the photovoltaic panel assemblies 100, 200, 300 to face generally south.

The panels 102, 104 are rotatable about generally parallel first and second rotational axes A and B, respectively, as shown in FIG. 1. The leaf springs 140, 142, 144, 146, 148 are configured to resiliently bias the photovoltaic panel 102 upwardly towards the first resting position in which the light receiving surfaces 114, 116, 118, 120 are oriented at a tilt angle of about 35° relative to the level ground. Similarly, the respective counterweights are configured to resiliently bias the light reflecting panel units 150, 152, 154, 156 towards the second resting position selected to reflect light or sunlight directed thereon to the photovoltaic modules 106, 108, 110, 112 positioned below. The second resting position may be for example about 69.7° or greater in summer or about 22.8° or greater in winter to avoid shading by the light reflecting panel 104 on the photovoltaic panel 102. To adjust the second resting position of the light reflecting panel 104, the mass of the counterweights and/or relative positioning of the counterweights and the second rotational axis B may be modified. Furthermore, although the light reflecting surface 158, 160, 162, 164 are shown in FIGS. 1 and 5 as being planar, the surfaces may be formed as generally concave surfaces to effect concentration and/or redirection of the sunlight onto the photovoltaic panel 102.

During operation, the photovoltaic system 10 may be subject to various environmental loads, such as a snow load imposed on the photovoltaic panel 102 during winter. It has been appreciated that with the resilient upward rotational biasing, snow accumulating on the photovoltaic panel 102 will gradually or incrementally rotate the panel 102 towards a downwardly rotated position in which the tilt angle of the panel 102 is greater than that in the first resting position. Such downward rotational movement of the photovoltaic panel 102 may provide for more suitable tilt angles in winter time when the solar elevation angle is reduced. Furthermore, when the photovoltaic panel 102 is sufficiently rotated downwardly to allow the snow to fall to the ground, or the snow accumulated on the panel 102 melts in spring, the panel 102 will be returned to the first resting position, and thus reduced tilt angle which may be more suitable for increased solar elevation angle in spring and summer.

Furthermore, the light reflecting panel 104 may be subject to a wind load. It has appreciated that by rotatably coupling the panel 104 to the base frame assembly 50, strains and stresses which may be caused by a wind directed at the panel 104 may be reduced with forward or rearward rotational movement of the panel 104 with the direction of the wind against the resilient bias of the counterweights.

While the invention has been described with reference to preferred embodiments, the invention is not or intended by the applicant to be so limited. A person skilled in the art would readily recognize and incorporate various modifications, additional elements and/or different combinations of the described components consistent with the scope of the invention as described herein.

We claim:

1. A photovoltaic system for converting sunlight to electricity, the system comprising a support frame assembly and a photovoltaic panel assembly, wherein the support frame assembly comprises a pair of laterally spaced panel mounting arms for placement on a mounting surface to extend generally upwardly therefrom, and wherein the photovoltaic panel assembly comprises:
a photovoltaic panel having an upper longitudinal end portion and a forwardly oriented light receptive surface, the upper longitudinal end portion being hingedly coupled along lengths of the panel mounting arms to permit at least partial rotational movement of the photovoltaic panel about a first generally horizontal rotational axis between a first resting position and a first rotated position, wherein in the first resting position, the light receptive surface is oriented at a first tilt angle between about 10° and 80° relative to the level ground, and in the first rotated position, the light receptive surface is oriented at a second tilt angle greater than the first tilt angle relative to the level ground;
a reflective panel having a lower panel portion and a forwardly oriented reflective surface, the lower panel portion being hingedly coupled along the lengths of the panel mounting arms to permit at least partial rotational movement of the reflective panel about a second rotational axis between a second resting position and a second forwardly rotated position, and optionally between the second resting position and a third rearwardly rotated position, wherein the second rotational axis is generally parallel to the first rotational axis; and
a biasing assembly comprising first and second biasing members, the first biasing member being positioned for resiliently biasing the photovoltaic panel towards the first resting position, and the second biasing member being positioned for resiliently biasing the reflective panel towards the second resting position,
wherein the lower panel portion is positioned adjacent to and generally above the upper longitudinal end portion, whereby the photovoltaic panel and the reflective panel in the respective first and second resting positions extend generally forwardly from the panel mounting arms to define a forwardly open inner wedge space therebetween, wherein the light receptive surface and the reflective surface are oriented generally inwardly towards each other to effect reflection of light or sunlight by the reflective surface at least in the second resting position to the light receptive surface.

2. The photovoltaic system of claim 1, wherein the first biasing member is selected to permit the rotational movement of the photovoltaic panel towards the first rotated position against the resilient bias under a load applied generally downwardly to the photovoltaic panel, the load being greater than an opposing threshold biasing force selected to maintain the photovoltaic panel in the first resting position, wherein the rotational movement of the photovoltaic panel towards the first rotated position is proportional to an amount of the load exceeding the threshold biasing force.

3. The photovoltaic system of claim 1, wherein the second biasing member is selected to permit the rotational movement of the reflective panel towards the second forwardly rotated position and optionally the third rearwardly rotated position against the resilient bias under a further load applied to the reflective panel, the further load being greater than a further opposing threshold biasing force selected to maintain the reflective panel in the second resting position, wherein the rotational movement of the reflective panel towards the second forwardly rotated position or the third rearwardly rotated position is proportional to an amount of the further load exceeding the further threshold biasing force.

4. The photovoltaic system of claim 2, wherein the load comprises an environmental load having at least a snow load caused by snow accumulating on the light receptive surface, and the light receptive surface has a friction coefficient selected to permit relative movement of the snow towards the mounting surface when the photovoltaic panel is in or proximal to the first rotated position, and wherein the further load comprises a wind load caused by wind directed to the reflective panel.

5. The photovoltaic system of claim 1, wherein in the second resting position, the reflective panel is oriented at a reflective angle relative to the level ground substantially equal to or greater than a solar elevation angle at a solar noon of a day, thereby avoiding shading of the light receptive surface by the reflective panel during the day.

6. The photovoltaic system of claim 1, wherein the photovoltaic panel assembly further comprises at least two photovoltaic panel hinges located on the upper longitudinal end portion for rotatably engaging associated said panel mounting arms, and at least two reflective panel hinges located on the lower panel portion for rotatably engaging associated said panel mounting arms, and wherein the first and second biasing members each comprises at least one of a leaf spring, a coil spring, a resiliently deformable bimetallic strip and a counterweight.

7. The photovoltaic system of claim 6, wherein the photovoltaic panel further comprises a lower longitudinal end portion opposed to the upper longitudinal end portion, and the first biasing member comprises two said leaf springs connected to the lower longitudinal end portion and associated said panel mounting arms, and wherein the reflective panel further comprises an upper panel portion opposed to the lower panel portion, and the second biasing member comprises at least one said counterweight positioned along the lower panel portion to cantilever the upper panel portion from the second rotational axis.

8. The photovoltaic system of claim 6, wherein the first biasing member comprises at least one said coil spring coupled to at least one said photovoltaic panel hinges, the coil spring being a metal coil spring oriented in general alignment with the first rotational axis, wherein the metal coil spring is positioned to increase the first tilt angle of the light receptive surface in the first resting position with decreasing temperature.

9. The photovoltaic system of claim 1, wherein the support frame assembly further comprises a pair of generally upright posts each having an upper end portion, each said post being for positioning on the mounting surface rearwardly from associated said panel mounting arm, and said associated panel mounting arm extending generally downwardly from the upper end portion towards the mounting surface at a frame angle between about 5° and about 60° relative to the post.

10. The photovoltaic system of claim 9, wherein the support frame assembly further comprises a generally horizontal crossbar extending between the panel mounting arms proximal to the mounting surface, and one or more inner mounting arms coupled to the crossbar to extend generally upwardly therefrom, the inner mounting arms being oriented generally parallel to the panel mounting arms, wherein the photovoltaic panel and the reflective panel are further hingedly coupled to the inner mounting arms.

11. The photovoltaic system of claim 1, further comprising a further one of said photovoltaic panel assembly, said further photovoltaic panel assembly being disposed generally below the photovoltaic panel assembly, wherein a most forward end of the respective photovoltaic panel of the photovoltaic panel assembly in the respective first resting position is positioned proximal to a most forward end of the respective reflective panel of the further photovoltaic panel assembly in the respective second resting position.

12. A photovoltaic system for converting sunlight to electricity, the system comprising a support frame assembly and a photovoltaic panel assembly, wherein the support frame assembly comprises a pair of laterally spaced panel mounting arms for placement on a mounting surface to extend generally upwardly therefrom, and wherein the photovoltaic panel assembly comprises:
a generally rectangular photovoltaic panel having an upper longitudinal end portion, a lower longitudinal end portion and a forwardly oriented light receptive surface, the upper longitudinal end portion being hingedly coupled along lengths of the panel mounting arms to permit at least partial rotational movement of the photovoltaic panel about a first generally horizontal rotational axis between a first resting position and a first rotated position, wherein in the first resting position, the light receptive surface is oriented at a first tilt angle between about 10° and 80° relative to the level ground, and in the first rotated position, the light receptive surface is oriented at a second tilt angle greater than the first tilt angle relative to the level ground;
a reflective panel having an upper panel portion, a lower panel portion and a forwardly oriented reflective surface, the lower panel portion being hingedly coupled along the lengths of the panel mounting arms to permit at least partial rotational movement of the reflective panel about a second rotational axis between a second resting position and a second forwardly rotated position, and optionally between the second resting position and a third rearwardly rotated position, wherein the second rotational axis is generally parallel to the first rotational axis; and
a biasing assembly comprising:
a first biasing member for resiliently biasing the photovoltaic panel towards the first resting position, wherein the first biasing member comprises at least two leaf springs connected to the lower longitudinal end portion and associated said panel mounting arms; and
a second biasing member for resiliently biasing the reflective panel towards the second resting position, wherein the second biasing member comprises at least one counterweight positioned along the lower panel portion to cantilever the upper panel portion from the second rotational axis,
wherein the lower panel portion is positioned adjacent to and generally above the upper longitudinal end portion, whereby the photovoltaic panel and the reflective panel in the respective first and second resting positions extend generally forwardly from the panel mounting arms to define a forwardly open inner wedge space therebetween, wherein the light receptive surface and the reflective surface are oriented generally inwardly towards each other to effect reflection of light or sunlight by the reflective surface at least in the second resting position to the light receptive surface.

13. The photovoltaic system of claim 12, wherein the first biasing member is selected to permit the rotational movement of the photovoltaic panel towards the first rotated position against the resilient bias under a load applied generally downwardly to the photovoltaic panel, the load being greater than an opposing threshold biasing force selected to maintain the photovoltaic panel in the first resting position, wherein the rotational movement of the photovoltaic panel towards the first rotated position is proportional to an amount of the load exceeding the threshold biasing force.

14. The photovoltaic system of claim 12, wherein the second biasing member is selected to permit the rotational movement of the reflective panel towards the second forwardly rotated position and optionally the third rearwardly rotated position against the resilient bias under a further load applied to the reflective panel, the further load being greater than a further opposing threshold biasing force selected to maintain the reflective panel in the second resting position, wherein the rotational movement of the reflective panel towards the second forwardly rotated position or the third rearwardly rotated position is proportional to an amount of the further load exceeding the further threshold biasing force.

15. The photovoltaic system of claim 13, wherein the load comprises an environmental load having at least a snow load caused by snow accumulating on the light receptive surface, and the light receptive surface has a friction coefficient selected to permit relative movement of the snow towards the mounting surface when the photovoltaic panel is in or proximal to the first rotated position, and wherein the further load comprises a wind load caused by wind directed to the reflective panel.

16. The photovoltaic system of claim 12, wherein in the second resting position, the reflective panel is oriented at a reflective angle relative to the level ground substantially equal to or greater than a solar elevation angle at a solar noon of a day, thereby avoiding shading of the light receptive surface by the reflective panel during the day.

17. The photovoltaic system of claim 12, wherein the photovoltaic panel assembly further comprises at least two photovoltaic panel hinges located on the upper longitudinal end portion for rotatably engaging associated said panel mounting arms, and at least two reflective panel hinges located on the lower panel portion for rotatably engaging associated said panel mounting arms.

18. The photovoltaic system of claim 12, wherein the support frame assembly further comprises a pair of generally upright posts each having an upper end portion, each said post being for positioning on the mounting surface rearwardly from associated said panel mounting arm, and said associated panel mounting arm extending generally downwardly from the upper end portion towards the mounting surface at a frame angle between about 5° and about 60° relative to the post.

19. The photovoltaic system of claim 18, wherein the support frame assembly further comprises a generally horizontal crossbar extending between the panel mounting arms proximal to the mounting surface, and one or more inner mounting arms coupled to the crossbar to extend generally upwardly therefrom, the inner mounting arms being oriented generally parallel to the panel mounting arms, wherein the photovoltaic panel and the reflective panel are further hingedly coupled to the inner mounting arms.

20. The photovoltaic system of claim 12, further comprising a further one of said photovoltaic panel assembly, said further photovoltaic panel assembly being disposed generally below the photovoltaic panel assembly, wherein a most forward end of the respective photovoltaic panel of the photovoltaic panel assembly in the respective first resting position is positioned proximal to a most forward end of the respective reflective panel of the further photovoltaic panel assembly in the respective second resting position.

21. A photovoltaic panel assembly for converting sunlight to electricity, the photovoltaic panel assembly being for attachment to a support frame positioned on a mounting surface in a mounted arrangement, wherein the photovoltaic panel assembly comprises:
a photovoltaic panel having opposed first and second longitudinal end portions and a light receptive surface, the first longitudinal end portion being for hingedly coupling to the support frame in the mounted arrangement to permit at least partial rotational movement of the photovoltaic panel about a first generally horizontal rotational axis between a first resting position and a first rotated position, wherein in the first resting position, the light receptive surface is oriented generally forwardly at a first tilt angle between about 10° and 80° relative to the level ground, and in the first rotated position, the light receptive surface is oriented generally forwardly at a second tilt angle greater than the first tilt angle relative to the level ground;
a reflective panel having opposed first and second panel portions and a reflective surface, the second panel portion being for hingedly coupling to the support frame in the mounted arrangement to permit at least partial rotational movement of the reflective panel about a second rotational axis between a second resting position and a second forwardly rotated position, and optionally between the second resting position and a third rearwardly rotated position, wherein the second rotational axis is generally parallel to the first rotational axis; and
a biasing assembly comprising first and second biasing members, the first biasing member being positionable in the mounted arrangement for resiliently biasing the photovoltaic panel towards the first resting position, and the second biasing member being positionable in the mounted arrangement for resiliently biasing the reflective panel towards the second resting position,
wherein in the mounted arrangement, the second panel portion is positionable adjacent to and generally above the first longitudinal end portion, whereby the first longitudinal end portion and the second panel portion in the respective first and second resting positions extend generally forwardly towards the second longitudinal end portion and the first panel portion, respectively, to define a forwardly open inner wedge space between the photovoltaic panel and the reflective panel, wherein the light receptive surface and the reflective surface are positionable generally inwardly towards each other to effect reflection of light or sunlight by the reflective surface at least in the second resting position to the light receptive surface.
